(19) United States
(12) Patent Application Publication
(10) Pub. No.: US 2026/0321676 A1
(43) Pub. Date: Oct. 15, 2026

(54) ELECTRODE

(71) Applicant: TOYOTA JIDOSHA KABUSHIKI KAISHA, Toyota-shi (JP)

(72) Inventors: Yasuhiro SAKASHITA, Nisshin-shi (JP); Suguru IKEYAMA, Toyota-shi (JP); Kazuhito KATO, Toyota-shi (JP); Yosuke SHIMURA, Nagakute-shi (JP); Takahiko NAKANO, Nagoya-shi (JP); Tomofumi HIRUKAWA, Miyoshi-shi (JP)

(73) Assignee: TOYOTA JIDOSHA KABUSHIKI KAISHA, Toyota-shi (JP)

(21) Appl. No.: 19/558,972

(22) Filed: Mar. 6, 2026

(30) Foreign Application Priority Data
Apr. 11, 2025 (JP) 2025-065758

(51) Int. Cl. H01M 4/70; H01M 4/66

(52) U.S. Cl. CPC H01M 4/70; H01M 4/667

(57) ABSTRACT

An electrode in which an electrode active material layer is coated on at least one surface of a collector having a sheet shape includes: a coated portion that is a portion of the collector, the coated portion being coated with the electrode active material layer; an uncoated portion that is a portion of the collector, the uncoated portion being not coated with the electrode active material layer; and a collector tab joined to the uncoated portion. A slit is provided in the uncoated portion, and the collector tab is joined to the uncoated portion at a position between the coated portion and the slit.

### CROSS-REFERENCE TO RELATED APPLICATION

This application claims priority to Japanese Patent Application No. 2025-065758 filed on Apr. 11, 2025. The disclosure of the above-identified application, including the specification, drawings, and claims, is incorporated by reference herein in its entirety.

### BACKGROUND

### 1. Technical Field

A technology disclosed in the present specification relates to an electrode.

### 2. Description of Related Art

Japanese Unexamined Patent Application Publication No. 2013-98026 (JP 2013-98026 A) discloses a strip-shaped electrode plate that is wound and stored in a battery, the electrode plate including a strip-shaped electrode portion provided with an electrode active material layer on its surface, and a collector portion that is provided in contact with an end part of the electrode portion in a width direction and is not provided with an electrode active material layer on its surface. According to JP 2013-98026 A, a plurality of slits is intermittently provided on a boundary line between the electrode portion and the collector portion or in parallel to the boundary line.

Japanese Unexamined Patent Application Publication No. 11-354103 (JP 11-354103 A) discloses an electrode plate for a secondary battery in which a plurality of notches that intersects a flow direction (a direction in which a coated portion in which an active material layer is provided when pressing is performed extends) and is arranged side by side is provided in an uncoated portion of a collector on which an active material layer is not coated.

### SUMMARY

As shown in JP 2013-98026 A, an electrode lead is connected to the collector portion (uncoated portion) in which the electrode active material layer is not provided. In a case where the electrode lead is connected to the uncoated portion in which the slit is provided, a flow of a current from the uncoated portion to the electrode lead is reduced because of the presence of the slit.

The present specification provides a technology that is useful for solving a problem in which the flow of the current is hindered because of the presence of the slit in the uncoated portion.

The present specification discloses an electrode in which an electrode active material layer is coated on at least one surface of a collector having a sheet shape. The electrode includes a coated portion that is a portion of the collector, the coated portion being coated with the electrode active material layer, an uncoated portion that is a portion of the collector, the uncoated portion being not coated with the electrode active material layer, and a collector tab joined to the uncoated portion. A slit is provided in the uncoated portion, and the collector tab is joined to the uncoated portion at a position between the coated portion and the slit.

According to the configuration, the slit is provided in the uncoated portion, and the collector tab is joined to the uncoated portion at the position between the coated portion and the slit. Therefore, the slit does not become a factor that hinders a flow of a current between the uncoated portion and the collector tab, and the current is likely to flow between the uncoated portion and the collector tab. In addition, the slit provided in the uncoated portion functions to reduce undulations or wrinkles (hereinafter, undulations or the like) caused by a difference in extension between the coated portion and the uncoated portion in a case where the electrode is pressed by a roller. As a result, occurrence of undulations or the like in the uncoated portion due to the pressing is reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an electrode sheet to be subjected to roll pressing from a viewpoint facing one surface of the electrode sheet;

FIG. 2 is an enlarged view of a slit provided in an uncoated portion;

FIG. 3 is a diagram schematically showing a state in which a collector tab is joined to the uncoated portion;

FIG. 4 is a cross-sectional view taken along a line IV-IV of FIG. 3;

FIG. 5 is a diagram schematically showing an example of a state in which the collector tab is joined to the uncoated portion, the example being different from the example of FIG. 3;

FIG. 6 is a cross-sectional view taken along a line VI-VI of FIG. 5;

FIG. 7 is a sectional view of a secondary battery; and

FIG. 8 is an exploded perspective view of an electrode laminate.

### DETAILED DESCRIPTION OF EMBODIMENTS

The main features of an embodiment described below are listed below. These features can be optionally combined.

In the electrode disclosed in the present specification, the slit may have a straight line portion and slit end portions provided at respective ends of the straight line portion; and the slit end portions may be provided by cutting the collector into a shape in which a width of the slit end portion in a direction intersecting a longitudinal direction of the straight line portion is larger than a width of the straight line portion.

According to the configuration, occurrence of undulations or the like in the uncoated portion is further reduced. In addition, breakage of the slit end portions is reduced.

In the electrode disclosed in the present specification, the slit end portions may each have a circular shape.

According to the configuration, the breakage of the slit end portions is further reduced.

In the electrode disclosed in the present specification, a ratio of a length of the uncoated portion to a length of the coated portion in a direction extending from the coated portion to the uncoated portion may be 2.5% or less.

According to the configuration, by setting the ratio to a low value of 2.5% or less, the size of the uncoated portion itself can be reduced to suppress undulations or the like in the uncoated portion.

In the electrode disclosed in the present specification, the collector tab may be further joined to the uncoated portion at a position that is farther from the coated portion than the slit is.

According to the configuration, joint strength between the collector tab and the uncoated portion can be increased.

The embodiment will be described with reference to the drawings. Each drawing is merely an example, and the present embodiment is not limited to the contents shown in the drawings. In addition, since the drawings are examples, some parts may be omitted.

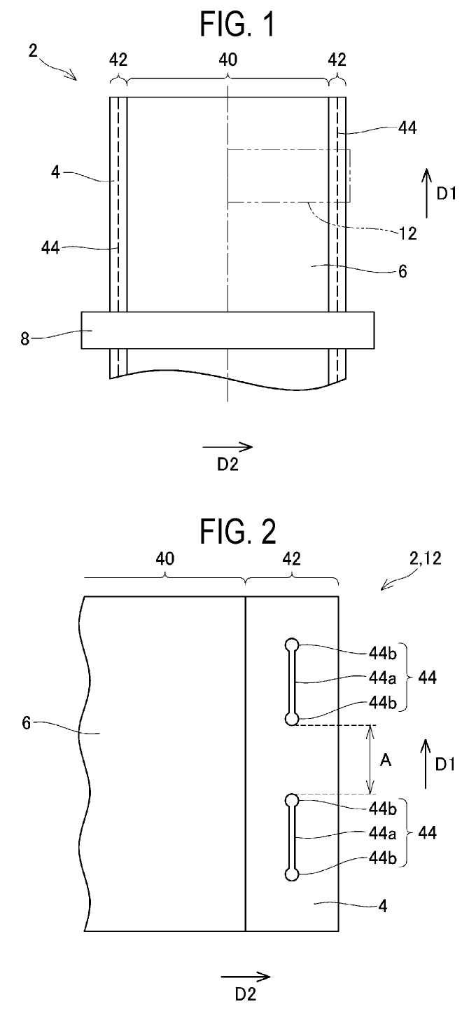

FIG. 1 schematically shows an electrode sheet 2 to be subjected to roll pressing from a viewpoint facing one surface of the electrode sheet 2. The electrode sheet 2 includes a collector 4 having a long sheet shape and an electrode active material layer 6 coated on at least one surface of the collector 4. The collector 4 is metal foil. A region of the collector 4 on which the electrode active material layer 6 is coated is referred to as a coated portion 40. A region of the collector 4 on which the electrode active material layer 6 is not coated is referred to as an uncoated portion 42. In FIG. 1, a reference numeral D1 indicates a longitudinal direction D1 of the electrode sheet 2, and a reference numeral D2 indicates a width direction D2 of the electrode sheet 2 orthogonal to the longitudinal direction D1. A first end and a second end of the electrode sheet 2 in the width direction D2 are the uncoated portions 42.

According to FIG. 1, a roller 8 that is long in the width direction D2 is in contact with the electrode sheet 2 transported along the longitudinal direction D1. In order to increase a density of the electrode active material layer 6 and to make a thickness of the electrode active material layer 6 uniform, the electrode sheet 2 is subjected to roll pressing at a predetermined pressing pressure using the roller 8. There has been a problem in which a difference in extension occurs between the coated portion 40 and the uncoated portion 42 during pressing, and undulations or the like occur in the uncoated portion 42 because of the difference in extension.

In order to address such a problem, a slit 44 is provided in the uncoated portion 42. The slit 44 is a notch that penetrates the collector 4. According to FIG. 1, the slit 44 is intermittently provided in the uncoated portion 42 along the longitudinal direction D1. In the uncoated portion 42, the slit 44 is provided at a position away from a boundary between the coated portion 40 and the uncoated portion 42.

FIG. 2 is an enlarged view of the slit 44 provided in the uncoated portion 42 from the same viewpoint as in FIG. 1. One slit 44 includes a straight line portion 44a and a slit end portion 44b provided at both ends of the straight line portion 44a. In the example of FIG. 2, a longitudinal direction of the straight line portion 44a is parallel to the longitudinal direction D1. The longitudinal direction of the straight line portion 44a may be inclined relative to the longitudinal direction D1. A ratio of the length of one slit 44 in the longitudinal direction D1 to a region (slit non-provided region) A in which the slit 44 is not provided between the slits 44 in the longitudinal direction D1 is, for example, 1:1. In another example, the ratio of the length of one slit 44 in the longitudinal direction D1 to the slit non-provided region A in the longitudinal direction D1 may be a ratio different from 1:1.

As shown in FIG. 2, the slit end portion 44b may be provided by cutting the collector 4 into a shape in which the width of the slit end portion 44b in a direction intersecting the longitudinal direction of the straight line portion 44a is larger than the width of the straight line portion 44a. That is, the slit end portion 44b is thicker than the straight line portion 44a. In FIG. 2, the width direction D2 corresponds to the direction intersecting the longitudinal direction of the straight line portion 44a. As shown in FIG. 2, the slit end portion 44b has, for example, a circular shape. The slit end portion 44b may be an oval or an ellipse. Alternatively, the slit end portion 44b may be a polygon.

The slit 44 provided in the uncoated portion 42 functions to reduce undulations or the like caused by the difference in extension between the coated portion 40 and the uncoated portion 42 in a case where the electrode sheet 2 is pressed. As a result, the occurrence of undulations or the like in the uncoated portion 42 is reduced. In addition, since the slit end portion 44b is provided in a shape in which the width of the slit end portion 44b is larger than the width of the straight line portion 44a, for example, in a circular shape, undulations or the like in the vicinity of the slit end portion 44b or breakage of the slit end portion 44b is reduced.

In the present embodiment, the size of the uncoated portion 42 is smaller than that in the related art. In FIG. 1, the size of one electrode 12 is shown by a two-dot chain line. The electrode sheet 2 after the roll pressing is cut, and separated into a plurality of electrodes 12 each having, for example, the size shown in FIG. 1. FIG. 2 shows a part of the electrode sheet 2, and this may be regarded as a part of one electrode 12. In a case of focusing on one electrode 12, for example, a ratio of the length of the uncoated portion 42 to the length of the coated portion 40 in a direction (in FIGS. 1 and 2, the width direction D2) in which the uncoated portion 42 extends from the coated portion 40 is 2.5% or less. For example, the length of the coated portion 40 in the width direction D2 of the electrode 12 is 200 mm or longer, and the length of the uncoated portion 42 in the width direction D2 of the electrode 12 is 5 mm or shorter. As described above, by reducing the size of the uncoated portion 42 itself, for example, by setting the ratio to a low value of 2.5% or less, undulations or the like in the uncoated portion 42 can be reduced.

In the present embodiment, a metal collector tab is joined to the uncoated portion 42 in correspondence with the reduction of the size of the uncoated portion 42 itself. That is, after the roll pressing of the electrode sheet 2 using the roller 8, the collector tab is joined to the uncoated portion 42. The timing at which the collector tab is joined to the uncoated portion 42 is before or after the roll-pressed electrode sheet 2 is cut into the electrodes 12.

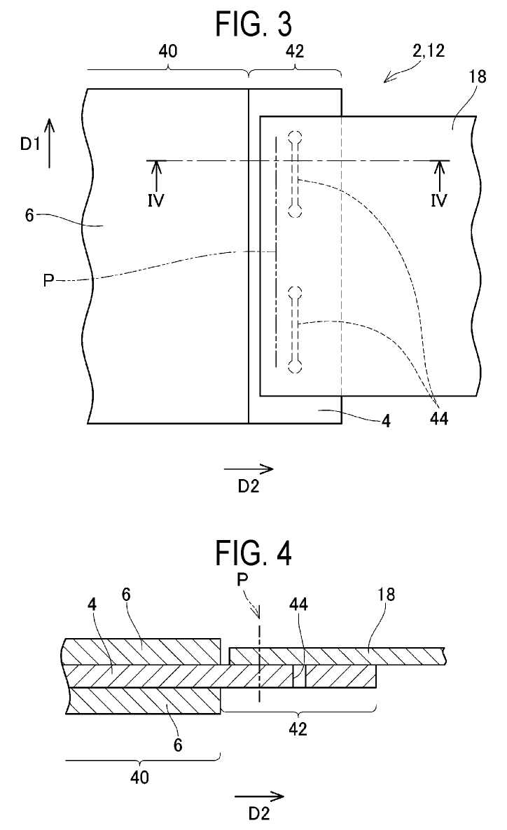

FIG. 3 shows a state in which a collector tab 18 is joined to one electrode 12 or to a region of the electrode sheet 2 corresponding to one electrode 12, from the same viewpoint as in FIGS. 1 and 2. FIG. 4 is a cross-sectional view taken along a line IV-IV of FIG. 3. According to FIG. 4, in the coated portion 40 of the electrode 12, the electrode active material layer 6 is provided on both surfaces of the collector 4. In FIGS. 3 and 4, a joint position P between the coated portion 40 and the slit 44 is indicated by a two-dot chain line. The collector tab 18 is joined to the uncoated portion 42 at the joint position P. That is, the collector tab 18 is joined to the uncoated portion 42 at a position between the coated portion 40 and the slit 44. The collector tab 18 is joined to the uncoated portion 42 at the joint position P by, for example, welding or bonding using an adhesive. The collector tab 18 joined to the uncoated portion 42 is electrically connected to an electrode terminal (not shown).

As described above, in the present embodiment, the slit 44 is provided in the uncoated portion 42 of the electrode 12, and the collector tab 18 is joined to the uncoated portion 42 at the position between the coated portion 40 and the slit 44. Therefore, the slit 44 does not become a factor that hinders a flow of a current between the uncoated portion 42 and the collector tab 18 (the current that flows between the coated portion 40 and the collector tab 18 through the uncoated portion 42), and the current is likely to flow between the uncoated portion 42 and the collector tab 18.

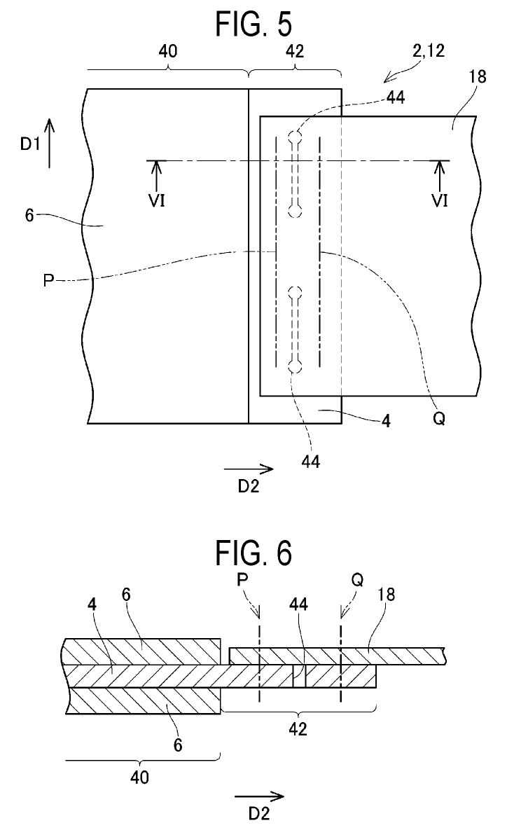

FIG. 5 shows a state in which the collector tab 18 is joined to one electrode 12 or to the region of the electrode sheet 2 corresponding to one electrode 12, in the same manner as in FIG. 3. FIG. 6 is a cross-sectional view taken along a line VI-VI of FIG. 5. Only the difference from FIGS. 3 and 4 will be described for FIGS. 5 and 6. FIGS. 5 and 6 show a joint position Q farther from the coated portion 40 than the slit 44 is. That is, the joint position Q is on the opposite side of the slit 44 from the joint position P. The collector tab 18 is joined to the uncoated portion 42 at the joint position Q in addition to the joint position P. That is, the collector tab 18 may be further joined to the uncoated portion 42 at a position farther from the coated portion 40 than the slit 44 is. As a result, joint strength between the collector tab 18 and the uncoated portion 42 can be increased. The joint position P may be referred to as a first joint position P, and the joint position Q may be referred to as a second joint position Q.

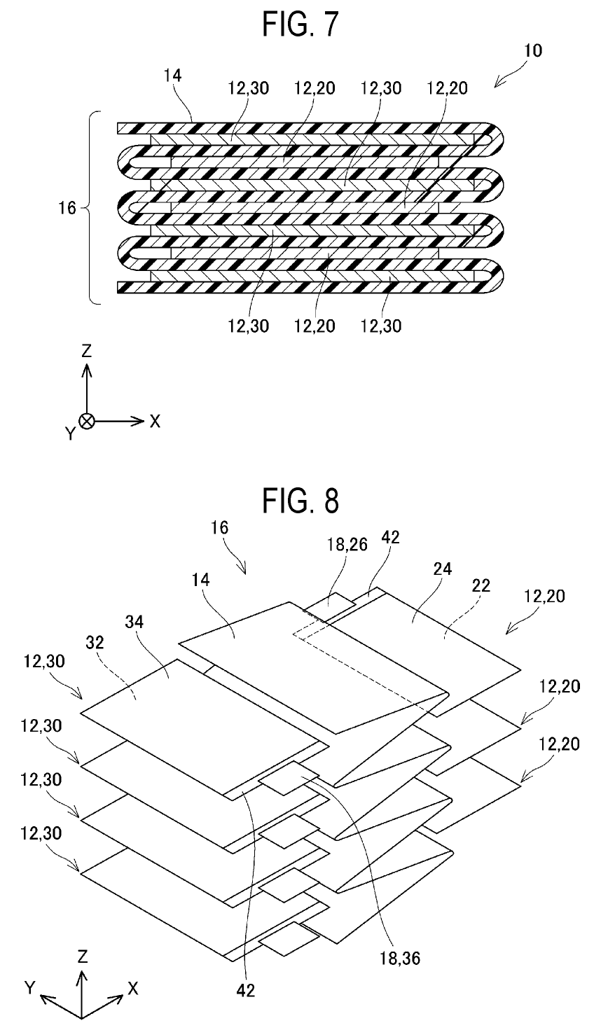

The electrode 12 is used as a part of a configuration of a secondary battery 10, for example, as shown in FIGS. 7 and 8. FIG. 7 schematically shows a section of the secondary battery 10. The secondary battery 10 is, for example, a chargeable and dischargeable lithium-ion battery. The secondary battery 10 includes an electrode laminate 16 provided by laminating the electrodes 12 in a first direction with a separator 14 placed between adjacent electrodes 12. FIG. 8 schematically shows an exploded perspective view of the electrode laminate 16. The electrodes 12 are positive electrodes 20 and negative electrodes 30.

The secondary battery 10 includes an exterior (not shown) having flexibility, and the electrode laminate 16 is sealed inside the exterior. An electrolytic solution (not shown) is sealed inside the exterior. The exterior is, for example, a laminate sheet. In FIGS. 7 and 8, for convenience of description, X, Y, and Z axes orthogonal to each other are shown. A Z axis direction corresponds to a first direction. The first direction may be referred to as a laminating direction. FIG. 7 is a sectional view taken along a section orthogonal to the Y axis.

As shown in FIGS. 7 and 8, the electrode laminate 16 is provided by alternately laminating the substantially rectangular positive electrodes 20 and the substantially rectangular negative electrodes 30 via a strip-shaped separator 14 pleated with alternating mountain and valley folds. In this case, each of the positive electrodes 20 is sandwiched between first surfaces of the separator 14, and each of the negative electrodes 30 is sandwiched between second surfaces of the separator 14. Each of the positive electrode 20 and the negative electrode 30 extends in an X axis direction and a Y axis direction. It should be noted that the Y axis direction in relation to the electrode 12 may correspond to the width direction D2 of FIGS. 1 to 6.

The separator 14 is made of a material having both permeability that allows movement of a charge carrier (here, a lithium ion) during charging and discharging and an insulating property that suppresses short-circuiting due to contact between the positive electrode 20 and the negative electrode 30. Examples of the material of the separator 14 include polypropylene and polyethylene. As shown in FIGS. 7 and 8, a configuration in which the pleated continuous separator 14 is sandwiched between the electrodes 12 is merely an example. The separators 14 sandwiched between the electrodes 12 may be separated from each other. In any case, the electrode laminate 16 is provided by alternately laminating the positive electrodes 20 and the negative electrodes 30 in the first direction with the separator 14 placed between adjacent positive electrodes 20 and negative electrodes 30.

According to FIG. 8, the positive electrode 20 includes a positive electrode collector 22 and a positive electrode active material layer 24 coated on the positive electrode collector 22. The positive electrode collector 22 corresponds to an example of the collector 4, and the positive electrode active material layer 24 corresponds to an example of the electrode active material layer 6. The positive electrode active material layer 24 is coated, for example, on both surfaces of the positive electrode collector 22. The positive electrode collector 22 is, for example, aluminum foil. The positive electrode active material layer 24 contains a positive electrode active material. Examples of the positive electrode active material include a lithium nickel-based composite oxide, a lithium cobalt-based composite oxide, and a lithium manganese-based composite oxide.

The negative electrode 30 includes a negative electrode collector 32 and a negative electrode active material layer 34 coated on the negative electrode collector 32. The negative electrode collector 32 corresponds to an example of the collector 4, and the negative electrode active material layer 34 corresponds to an example of the electrode active material layer 6. The negative electrode active material layer 34 is coated, for example, on both surfaces of the negative electrode collector 32. The negative electrode collector 32 is, for example, copper foil. The negative electrode active material layer 34 contains a negative electrode active material. Examples of the negative electrode active material include a carbon material such as graphite, hard carbon, and soft carbon, a material such as silicon (Si) that forms an alloy with lithium, and a lithium alloy. The electrode active material may include a single kind of material or a plurality of kinds of materials. The electrode active material layer may contain a conductive auxiliary agent, a binder, and the like.

Each of the electrodes 12 (positive electrodes 20 and negative electrodes 30) includes the collector tab 18 that protrudes in a second direction intersecting the first direction. Here, the Y axis direction (Y axis + direction and Y axis - direction) corresponds to the second direction. According to FIG. 8, the uncoated portion 42 of the positive electrode 20 protrudes in the Y axis + direction, and the collector tab 18, that is, a positive electrode collector tab 26, is joined to the uncoated portion 42. In addition, according to FIG. 8, the uncoated portion 42 of the negative electrode 30 protrudes in the Y axis - direction, and the collector tab 18 of the negative electrode 30, that is, a negative electrode collector tab 36, is joined to the uncoated portion 42. The positive electrode collector tab 26 and the negative electrode collector tab 36 protrude outward of a region interposed by the separator 14 in opposite directions to each other. The positive electrode collector tab 26 included in each of the positive electrodes 20 is electrically connected to a positive electrode terminal (not shown). The negative electrode collector tab 36 included in each of the negative electrodes 30 is electrically connected to a negative electrode terminal (not shown). The feature of the electrode 12 including the collector tab 18 described with reference to FIGS. 1 to 6 can be applied to each of the positive electrode 20 including the positive electrode collector tab 26 and the negative electrode 30 including the negative electrode collector tab 36.

Although specific examples of the technology disclosed in the present specification have been described in detail above, these examples are merely illustrative and do not limit the scope of the claims. The technology described in claims includes various modifications and changes of the specific examples illustrated above. The technical elements described in the present specification or the drawings exhibit technical usefulness alone or in various combinations, and are not limited to the combinations described in the claims at the time of filing. Further, the technology exemplified in the present specification or the drawings can achieve a plurality of objectives at the same time, and achieving one of the objectives has technical usefulness.

What is claimed is:

1. An electrode in which an electrode active material layer is coated on at least one surface of a collector having a sheet shape, the electrode comprising:
a coated portion that is a portion of the collector, the coated portion being coated with the electrode active material layer;
an uncoated portion that is a portion of the collector, the uncoated portion being not coated with the electrode active material layer; and
a collector tab joined to the uncoated portion, wherein:
a slit is provided in the uncoated portion; and
the collector tab is joined to the uncoated portion at a position between the coated portion and the slit.

2. The electrode according to claim 1, wherein:
the slit includes a straight line portion and slit end portions provided at respective ends of the straight line portion; and
the slit end portions are provided by cutting the collector into a shape in which a width of the slit end portion in a direction intersecting a longitudinal direction of the straight line portion is larger than a width of the straight line portion.

3. The electrode according to claim 2, wherein the slit end portions each have a circular shape.

4. The electrode according to claim 1, wherein a ratio of a length of the uncoated portion to a length of the coated portion in a direction extending from the coated portion to the uncoated portion is 2.5% or less.

5. The electrode according to claim 1, wherein the collector tab is further joined to the uncoated portion at a position that is farther from the coated portion than the slit is.
